(19) United States
(12) Patent Application Publication
(10) Pub. No.: US 2006/0056296 A1
(43) Pub. Date: Mar. 16, 2006

(54) System and method for using a scheduler based on virtual frames

(75) Inventors: Sai Shankar Nandagopalan, Tarrytown, NY (US); Sunghyun Choi, Kwanak-Gu (KR); Atul Garg, Sunyvale, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/537,594

(22) PCT Filed: Dec. 3, 2003
(86) PCT No.: PCT/IB03/05596

§ 371 Date: Jun. 6, 2005

Related U.S. Application Data
(60) Provisional application No. 60/431,843, filed on Dec. 9, 2002.

(51) Int. Cl. H04L 12/26

(52) U.S. Cl. 370/230

(57) ABSTRACT

Disclosed is a method and system based on virtual frames for enabling a QAP to seamlessly operate between granting polls for upstream and sidestream traffic while sending downstream frames. A key feature of the scheduling method of the invention is that the scheduling method generates virtual frames to create transmission opportunity durations for granting polls for the upstream and sidestream traffic.

The present invention relates generally to communication systems, and more particularly, the present invention has particular application to the field of wireless communication systems and in this aspect relates to a scheduler and related method for efficiently granting polls to upstream and/or sidestream traffic and sending downstream frames.

Scheduling is essential in providing quality of service (QoS) in data networks where multiple users share common resources. This is especially true in the context of wireless links. That is, the time-varying nature of wireless links presents great challenges in the design of scheduling policy in wireless data services because of the scarcity of radio resource and the time-varying nature of radio quality. Currently, most scheduling policies are dependent on the queue length or arrival rate or time stamps present in a transmitted medium access control (MAC) frame and do not consider the channel capacity. This would suffice if the channel capacity to all users were constant as is the case in wireline systems. However, in the context of wireless networks, a drawback of these schemes is that they always result in an under-utilization of the wireless resources by not accounting for the channel capacity (i.e., the channel condition and continuously varying transmission rate).

Currently, the 802.11 MAC offers a simplified model, referred to as a “best-effort” model. In the simplified scheme, all frames receive the same level of service with no distinction for frames from different applications. In accordance with the model, an attempt is made to forward frames as soon as possible, but makes no quantitative commitments about the quality of service (QoS) provisioning. But with the advent of 802.11e, which is a quality of service MAC, a scheduler is need that will guarantee the QoS requirements for different streams.

Accordingly, there is a need for a scheduling policy that can be incorporated on top of the IEEE 802.11e/D3.3. draft standard enabling an QoS access point (QAP) to take into account the QoS requirements of the stream and schedule appropriately.

The present invention is directed to a scheduling method based on virtual frames for use in a wireless local area network (WLAN) that enables a QAP to seamlessly operate between granting polls for upstream and sidestream traffic while sending downstream frames. A key feature of the scheduling method of the invention is that the scheduling method generates virtual frames to create transmission opportunity durations for granting polls for the upstream and sidestream traffic. By scheduling virtual frames at the QAP for the sidestream/upstream traffic, all of the sidestream/upstream traffic is perceived by the scheduler as one large downstream frame to be seamlessly scheduled along with the conventional downstream traffic. According to an aspect of the invention, there is provided a scheduling method based on virtual frames for use in a WLAN. The method comprising the steps of: (a) determining, at said QAP, whether there is at least one upstream traffic stream intended for transmission from said at least one WSTA to said QAP; (b) determining, at said QAP, whether there is at least one sidestream traffic stream intended for transmission from said at least one WSTA to at least one other WSTA; (c) negotiating an intended upstream data rate of transmission, at said QAP, for transmitting said at least one upstream traffic stream from said at least one WSTA, when said determination step (a) is true; (d) negotiating an intended sidestream data rate of transmission, at said QAP, for transmitting said at least one sidestream traffic stream from said at least one WSTA to said at least one other WSTA, when said determination step (b) is true; (e) computing polling and transmission times, at said QAP, for polling said at least one WSTA in accordance with said negotiated upstream and sidestream intended data rates of transmission; (f) generating upstream virtual frames including said computed upstream polling and transmission times and airtimes allocated to the said WSTA, at said QAP, to transmit said at least one upstream traffic stream at said computed polling times; (g) generating sidestream virtual frames including said computed sidestream polling and transmission times and airtimes allocated to said WSTA, at said QAP, to transmit said at least one sidestream traffic stream at said computed polling times; and (h) scheduling the transmission of said upstream and sidestream virtual frames at said computed polling and transmission times.

In the preferred embodiment, the above method is carried out by an QAP comprising a virtual frame generator for determining the time instants when the QAP is required to poll the WSTAs to transmit said upstream and/or sidestream traffic; and a scheduler unit for computing polling and transmission times to poll said at least one WSTA.

A more complete understanding of the method and apparatus of the present invention may be had by reference to the following detailed description when taken in conjunction with the accompanying drawings wherein:

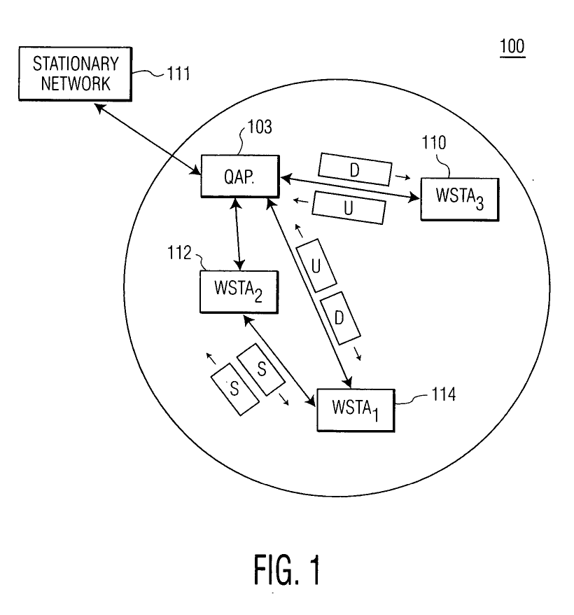

FIG. 1 illustrates the architecture of a wireless communication system whereto embodiments of the present invention are to be applied;

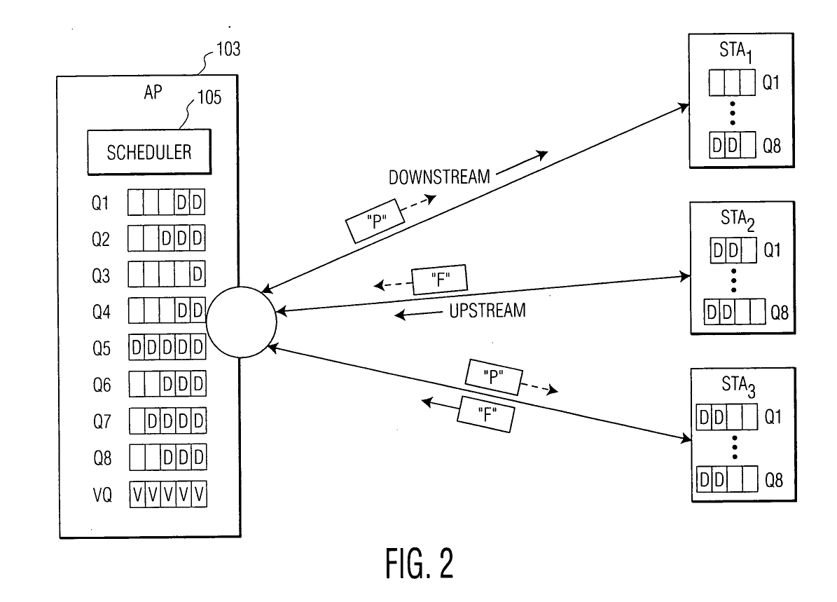

FIG. 2 illustrates a queue level description of the network of FIG. 1 according to an embodiment of the invention;

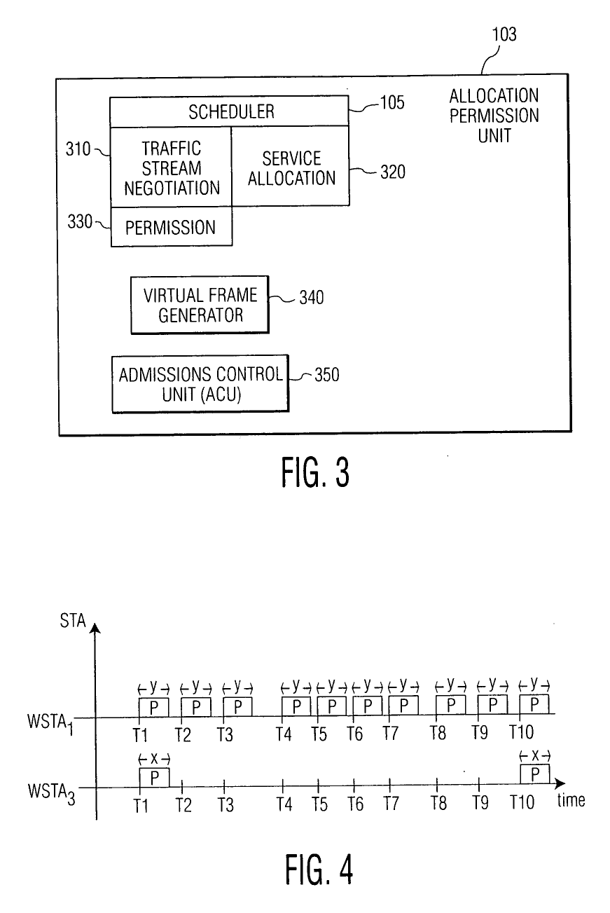

FIG. 3 is a block diagram of a QAP according to an embodiment of the invention; and

FIG. 4 illustrates a timing diagram to explain the polling procedure according to an embodiment of the invention.

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

The inventive method is a scheduling algorithm that utilizes virtual frames for upstream and sidestream scheduling in wireless local area networks (WLANs). The method is intended for implementation by an access point (QAP) in a QBSS network. To the best of the applicant's knowledge, the concept of virtual frames was first introduced in Sunghyun Choi and Kang G. Shin,” A Unified Architecture of Wireless Networks for Real-Time and Non-Real time Communication Services,” IEEE/ACM Trans. On Networking, vol. 8, no. 1, pp. 44-59, February, 2000, incorporated by reference herein in its entirety. However, it is believed that the use of virtual frames in the context of wireless LANS has heretofore not been considered. It is to this end that the present application is directed. That is, the method of the present invention introduces the use of virtual frames in the context of wireless LANS, in a manner that enables an QAP to seamlessly operate between granting polls to associated stations (WSTAs) for upstream and/or sidestream traffic and the sending of downstream frames to the WSTAs, as will be described in greater detail below.

FIG. 1 is an illustration of a representative network 100 whereto embodiments of the present invention may be applied. As shown, FIG. 1 illustrates a QBSS network 100 including an QAP 103 coupled to a stationary network 111 and a plurality of stations (WSTA₁ through WSTA₃) 110, 112, 114. A primary function of the QAP 103 is to facilitate the transmission of data packets. Data packets include “upstream” packets (i.e., packets transmitted in a direction from the WSTAs 110-114 to the QAP 103), labeled as “U”, “downstream” packets (i.e., packets transmitted in a direction from the QAP 103 to the WSTAs 110-114), labeled as “D”, and “sidestream” packets (i.e., packets transmitted from one WSTA 110-114 to another WSTA), labeled as “S”. It should be noted that the network shown in FIG. 1 is small for purposes of illustration. In practice, most networks would include a much larger number of mobile WSTAs.

FIG. 2 is a block diagram of one embodiment of a queue level representation of the QAP 103 and WSTAs₁₋₃ 110-114 of the network 100 of FIG. 1. As shown, the QAP 103 maintains 9 queues, 8 of which are conventional, Q1-Q8, and a ninth queue, which is the key feature of the invention, referred to hereafter as a virtual queue VQ. Queues 1 through 8 contain real data (i.e., data packets or frames which are transmitted as part of an MPDU). By contrast, the virtual queue VQ contains only virtual frames, as will be described.

Referring now to FIG. 3, a block diagram of the functional elements of the QAP of FIG. 2 are shown. The QAP includes a scheduler 105 which can be broken down into two main functions, traffic stream negotiation 310 and service allocation 320. Traffic stream negotiation 310 further comprises a permission 330 sub-function. The AP further includes a virtual frame generator module 340 for determining the time instants when the AP is required to poll the WSTAs for upstream and/or sidestream traffic. The QAP further includes an admissions control unit 350 for computing in advance, via a scheduling algorithm, polling times to poll each WSTA 110-114 desiring to transmit traffic upstream so as to satisfy the WSTA's 110-114 pre-negotiated data rates.

The present invention is directed exclusively to the scheduling of parameterized QoS traffic. As defined by the IEEE 802.11 standard, parameterized traffic is identified by priority values in the range 8 to 15 which are included as part of a 16 bit QoS control field in the MAC header of each frame. The priority values 8-15 are interpreted as traffic stream identifiers (TSID). Parameterized traffic could include, for example, video telephone, low cost video conferencing, imaging, High Definition Television (HDTV), streaming audio and/or video and so on. Each of the afore-mentioned applications may place different demands on the wireless communications network 100 depending upon their respective bandwidth requirements. That is, some applications described above are more bit intensive than others (e.g., an HDTV video stream at 24 Mbps). In general, most real time applications qualify as being bit intensive and as such place high demands on the transmission network 100. Other applications, such as stereophonic audio which is typically transmitted at 128 Kbps is comparably less bit intensive and consequently less demanding on the network 100 resources. Therefore, a mechanism is needed to efficiently schedule these disparate network demands for processing by the network 100.

To perform scheduling in an efficient manner at the QAP 103, the scheduler 105 must control two processes: (1) determine the existence of any upstream streams that the WSTAs 110-114 intend to transmit to the QAP 103 (2) determine if there is data required to be sent downstream from the stationary network 111, via the QAP 103, to the WSTAs 110-114. The first process is achieved in a polling operation performed by the scheduler 105 at the QAP 103. In the polling operation, the scheduler 105 determines which WSTAs have traffic streams to be transmitted upstream to the QAP 103. Once it is determined by the scheduler 105 that one or more WSTAs 110-114 have traffic streams to be transmitted upstream to the QAP 103, a negotiation session is conducted between the QAP 103 and the one or more WSTAs 110-114 intending to transmit data upstream. The negotiation session is conducted by the traffic stream negotiation unit 310 of the QAP 103

As part of the negotiation session, a permission protocol is invoked by the QAP 103 to grant permission to the requesting WSTA. A permission unit 330 is shown in FIG. 3 as a sub-process of the negotiation unit 310. Once permission is granted to an WSTA, the negotiation process then proceeds by the requesting WSTA, which has been granted permission, informing the QAP 103 of certain parameters related to the traffic stream to be transmitted, including the data rate and other traffic characteristics. Upon receiving these parameters at the QAP 103, an admissions control unit 350 associated with the QAP 103 (See FIG. 3) collects the parameter data for each traffic stream (i.e., requesting WSTA) compute in advance a time instance for polling the various WSTAs requesting to transmit data upstream to the WSTA, in a manner that satisfies a pre-negotiated data rate. Once the polling times are calculated by the QAP 103, virtual frames are then generated to poll the WSTA's at the computed time instances. It is noted that the virtual frames are actually polling frames for polling the various WSTAs at the appropriate times.

The following exemplary embodiment is provided to further clarify the method of the invention. Assume, for the purpose of explanation, that there are some numbers of WSTAs 110-114 in the network 100 of FIG. 1 that desire to transmit traffic upstream to the QAP 103. For example, assume WSTA₁ 110 needs to send HDTV video at 24 Mbps upstream to the QAP 103 and that WSTA₃ 114 needs to send stereophonic audio data at 128 kbps upstream to the QAP 103. As described above, it is the responsibility of the QAP 103 to determine the existence of these intended data streams for upstream transmission. In particular, the admission control unit (ACU) 350 of the QAP 103 determines whether there are any streams from WSTAs 110-114 intended for upstream transmission. Once the QAP 103 is made aware of these traffic streams, the scheduler 300 then negotiates with each WSTA 110-114 having a data stream to transmit upstream, to ascertain the WSTA's intended data rates of transmission (e.g., 24 Mbps for WSTA 110, 128 kbps for WSTA 114) as well as other transmission parameters of interest. Once the data rates are determined by the QAP 103, the ACU 350 computes in advance, via a scheduling algorithm, polling times to poll each WSTA 110-114 such that the WSTAs respective pre-negotiated data rates may be satisfied. It is noted that the details of the scheduling algorithm for negotiating the respective data rates are not central to the instant application and as such will not be discussed further.

Polling frames are then generated by the scheduler 105 based on the computed polling times of the upstream or sidestream sessions. The virtual frame generator in the QAP 103 uses this schedulable information and inserts into the virtual frame queue (VQ) the virtual frames with a time instance when they need to be exactly transmitted onto the channel. For the scheduler this basically takes into account all of the upstream and sidestream sessions.

The scheduler now uses this virtual frame queue (VQ) and the conventional downstream frame queues Q1-Q8 to schedule downstream sessions or upstream and/or sidestream sessions accordingly. It is noted that there is a QoS guarantee on satisfying the intended data rates, however, the method of the invention is more sophisticated than a ‘best efforts’ attempt of the prior art.

Referring now to FIG. 4, a timing diagram illustrating the polling times computed at the QAP 103 for the exemplary embodiment in which it is assumed that two WSTAs 110, 114 intend to transmit data upstream to the QAP 103 at data rates of 24 Mbps and 128 Kbps, respectively. First, with regard to WSTA₃ 114, assuming a packet size of 128 bits, to satisfy a data rate of 128 kbps, WSTA₃ 114 must send a packet every 1 ms. Similarly, assuming a packet size of 2400 bits, to satisfy a data rate of 24 Mbps, WSTA₁ 110 must send a packet every 100 μs. Therefore, the ACU 350 must poll WSTA₁ ten times (10×) as often as WSTA₃ 114.

FIG. 4 illustrates that the ACU 350 of the QAP 103 polls WSTA₃ ten times as often as WSTA₁ 110. It should be noted that the time intervals T1-T10 are not equidistant time intervals but are instead calculated in accordance with the scheduling algorithm so as to satisfy the intended data rates. As shown, at each polling instance along the time line (e.g., T1 through T10), WSTA₃ 114 is polled for a time duration denoted as “x” and WSTA₁ 110 is polled for a time duration denoted as “y”. Time durations, “x” and “y” are not fixed, but are instead dependent on the particular scheduling algorithm used. However, it is not the focus of the present invention to determine time durations x and y. Instead, the present invention is directed to the generation of the virtual frames that have time durations, x, y, associated therewith. It is also noted that these time durations may be extended as necessary if there are additional packets to be transmitted upstream at a particular polling interval.

Thus far, a process for sending upstream and/or sidestream traffic has been discussed. However, the present invention is equally directed to a concurrent process. That being the transmission of frames downstream from the stationary network 111, via the QAP 103, to the one or more WSTAs 110-114. In accordance with this process, the WSTAs 110-114 make various data requests from the stationary network 111 for data which could include, for example, any of the parameterized data categories discussed above (e.g., video telephone, low cost video conferencing, imaging, High Definition Television (HDTV), streaming audio and/or video and so on). To satisfy these data requests at the required data rates, the QAP 103 must perform the steps discussed above which generally include performing a scheduling computation to determine polling times and generate virtual frames therefrom. The steps required to send traffic downstream are identical to those previously described for sending traffic upstream with the only notable distinction being the direction of the intended traffic.

An advantage of the invention is that the QAP 103 is able to seamlessly grant polls (i.e., virtual frames) for the upstream and/or sidestream traffic and simultaneously send downstream traffic to the WSTAs.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. In a wireless communications network having at least one access point (QAP) and at least one station (WSTA), a method for seamlessly granting polls for upstream and/or sidestream traffic while simultaneously sending downstream traffic from said QAP to said at least one WSTA, the method comprising the steps of:
(a) determining, at said QAP, whether there is at least one upstream traffic stream intended for transmission from said at least one WSTA to said QAP;
(b) determining, at said QAP, whether there is at least one sidestream traffic stream intended for transmission from said at least one WSTA to at least one other WSTA;
(c) negotiating an intended upstream data rate of transmission, at said QAP, for transmitting said at least one upstream traffic stream from said at least one WSTA, when said determination step (a) is true;
(d) negotiating an intended sidestream data rate of transmission, at said QAP, for transmitting said at least one sidestream traffic stream from said at least one WSTA to said at least one other WSTA, when said determination step (b) is true;
(e) computing polling and transmission times, at said QAP, for polling said at least one WSTA in accordance with said negotiated upstream and sidestream intended data rates of transmission;
(f) generating upstream virtual frames including said computed upstream polling and transmission times and airtimes allocated to the said WSTA, at said QAP, to transmit said at least one upstream traffic stream at said computed polling times;
(g) generating sidestream virtual frames including said computed sidestream polling and transmission times and airtimes allocated to said WSTA, at said QAP, to transmit said at least one sidestream traffic stream at said computed polling times; and
(h) scheduling the transmission of said upstream and sidestream virtual frames at said computed polling and transmission times.

2. The method of claim 1, further comprising the steps of:
determining, at said at least one QAP, whether there is at least one downstream traffic stream intended for transmission from said at least one QAP to said at least one WSTA; and
if so, scheduling, at the QAP, the transmission of said at least one downstream traffic stream simultaneous with said steps (a) through (h) of claim 1.

3. The method of claim 1, wherein said negotiating step (c) further comprises the step of granting permission from said QAP to said at least one WSTA to transmit at least one upstream traffic stream at said negotiated upstream intended data rate.

4. The method of claim 1, wherein said negotiating step (d) further comprises the step of granting permission from said QAP to said at least one WSTA to transmit at least one sidestream traffic stream at said negotiated sidestream intended data rate.

5. The method of claim 2, wherein said upstream and sidestream traffic streams are parameterized traffic streams.

6. The method of claim 2, wherein said downstream traffic stream is a parameterized traffic stream.

7. The method of claim 1, wherein said polling frames are virtual frames.

8. A system for seamlessly granting polls for upstream and/or sidestream traffic while simultaneously sending downstream traffic from said (AP) to said at least one WSTA, the system comprising:
means for determining, at said QAP, whether there is at least one upstream traffic stream intended for transmission from said at least one WSTA to said QAP;
means for determining, at said QAP, whether there is at least one sidestream traffic stream intended for transmission from said at least one WSTA to at least one other WSTA;
means for negotiating an intended upstream data rate of transmission, at said QAP, for transmitting said at least one upstream traffic stream to said at least one WSTA, when said determination step (a) is true;
means for negotiating an intended sidestream data rate of transmission, at said at least one QAP, for transmitting said at least one sidestream traffic stream from said at least one WSTA to said at least one other WSTA, when said determination step (b) is true;
means for computing polling and transmission times, at said QAP, for polling said at least one WSTA in accordance with said negotiated upstream and sidestream intended data rates of transmission;
means for generating upstream virtual frames including said computed upstream polling and transmission times, at said QAP, to transmit said at least one upstream traffic stream at said computed polling times;
means for generating sidestream virtual frames including said computed sidestream polling and transmission times, at said QAP, to transmit said at least one sidestream traffic stream at said computed polling times; and
means for scheduling the transmission of said upstream and sidestream virtual frames at said computed polling and transmission times.

9. The system of claim 8, further comprising:
means for determining, at said QAP, whether there is at least one downstream traffic stream for transmission to said at least one WSTA; and
a means for scheduling, at said QAP, the transmission of said at least one downstream traffic stream.

10. A system for seamlessly granting polls by an access point (QAP) for upstream and/or sidestream traffic from at least one station (WSTA) while simultaneously sending downstream traffic from said QAP to said at least one WSTA, the system comprising:
said QAP comprising:
a virtual frame generator for determining the time instants when the QAP is required to poll the at least one WSTA to transmit said upstream and/or sidestream traffic; and
a scheduler unit for computing polling and transmission times to poll said at least one WSTA.

11. A system for seamlessly granting polls by an access point (QAP) for upstream and/or sidestream traffic from at least one station (WSTA) while simultaneously sending downstream traffic from said (QAP) to said at least one WSTA, the system comprising:
a memory for storing a computer-readable code; and,
a processor operatively coupled to said memory, said processor configured to:
(1) determine, at said QAP, whether there is at least one upstream and/or sidestream traffic stream intended for transmission from said at least one WSTA to said QAP in a QBSS;
(2) negotiate an intended data rate of transmission for said at least one upstream and/or sidestream traffic stream;
(3) compute polling times for polling said at least one WSTA desiring to transmit said at least one upstream and/or sidestream traffic stream;
(4) generate virtual frames corresponding to said computed polling times; and
(5) schedule the transmission of said virtual frames at said computed polling times.

12. The system of claim 11, wherein said processor is further configured to:
determine, at said QAP, whether there is at least one downstream traffic stream for transmission to said at least one WSTA; and
schedule, at the QAP, the transmission of said at least one downstream traffic stream.
